(19) United States
(12) Patent Application Publication
(10) Pub. No.: US 2018/0365597 A1
(43) Pub. Date: Dec. 20, 2018

(54) SERVICE PROVIDER APPOINTMENT BOOKING SYSTEM

(71) Applicant: Microsoft Technology Licensing, LLC, Redmond, WA (US)

(72) Inventors: Terry Farrell, Dublin (IE); David Mowatt, Dublin (IE)

(21) Appl. No.: 15/622,962

(22) Filed: Jun. 14, 2017

(51) Int. Cl. G06Q 10/02

(52) U.S. Cl. CPC G06Q 10/02

(57) ABSTRACT

Systems, methods, and software are disclosed herein for booking service provider appointments. In an implementation, program instructions direct a processing system to enumerate a set of customers requesting a service and identify a set of available service providers able to provide the service. For a selected service provider, the program instructions direct the processing system to notify the selected service provider of a potential booking, calculate a plurality of scores for the potential booking, generate guidance for the selected service provider regarding effects of accepting the potential booking and effects of rejecting the potential booking based on the plurality of scores, and communicate the guidance to be presented to the selected service provider. The program instructions further direct the processing system to receive an input decision from the selected service provider regarding the potential booking and communicate the input decision to be presented to the requesting customer.

### TECHNICAL BACKGROUND

A variety of service providers providing services to clients have fixed locations that clients travel to in order to receive the service. Such service providers may include manicurists, counsellors, singing teachers, mortgage consultants, financial consultants, insurance brokers, language tutors, solicitors, and the like. However, some service providers may offer their services at the client's location. For example, the service provider may meet the client in his home, workplace, or other location. In this manner, the service provider can accommodate the client by meeting with the client in a location more convenient for the client.

When providing the service to the client, the service provider will frequently require the client's attention. Given frequent demands on time with people's personal and work lives, it may be difficult for the client to find an ideal time to meet with the service provider that is convenient and suitable for both the client and service provider.

It may be convenient, for example, to meet with a client travelling from one location to another. For example, a frequent downtime for many clients is the time spent commuting/travelling to and from work using a transport service such as a taxi or ride sharing service. The client may be able to provide attention to the service provider during the journey when distractions at either location would otherwise intervene. However, the service provider may not want to arrive with the client at the final destination if the final destination is inconvenient for the service provider. In such a case, the service provider may decline to provide the services and lose out on the opportunity to provide service to this client. Alternatively, the service provider may offer to provide the service but at a higher rate than normal to make up the inconvenience of needing to travel alone back to a more convenient location with no opportunity of providing service to a different client during the return trip.

Thus, it would be advantageous to provide a booking system that guides mobile service providers to set service appointments in a manner that overcomes the aforementioned drawbacks.

### Overview

Examples discussed herein relate to a booking system for service providers to provide services to clients while in transit in a shared vehicle. In an implementation, a computing apparatus comprises one or more computer readable storage media, a processing system operatively coupled with the one or more computer readable storage media, and program instructions stored on the one or more computer readable storage media for booking service provider appointments. The program instructions, when executed by the processing system, direct the processing system to enumerate a set of customers requesting a service from a pool of service providers and identify a set of available service providers able to provide the service to a requesting customer of the set of customers. For a selected service provider of the set of available service providers, the program instructions direct the processing system to notify the selected service provider of a potential booking, calculate a plurality of scores for the potential booking, generate guidance for the selected service provider regarding effects of accepting the potential booking and effects of rejecting the potential booking based on the plurality of scores, and communicate the guidance to be presented via a service provider user interface system to the selected service provider. The program instructions further direct the processing system to receive an input decision from the selected service provider regarding the potential booking and communicate the input decision to be presented via a customer user interface system to the requesting customer.

In another implementation, a method for booking service provider appointments comprises identifying a requesting customer seeking a service provided by a service provider and identifying an availability of the service provider to be able to provide the service to the requesting customer. If the service provider is available, the method includes notifying the service provider of a potential booking, calculating a plurality of scores for the potential booking, generating guidance for the service provider regarding effects of accepting the potential booking and effects of rejecting the potential booking based on the plurality of scores, and communicating the guidance to be presented via a service provider user interface system to the selected service provider. The method further includes receiving an input decision from the service provider regarding the potential booking and communicating the input decision to be presented via a customer user interface system to the requesting customer.

In another implementation, one or more computer readable storage media having program instructions stored thereon for allocating parking spaces in a parking lot, wherein the program instructions, when executed by a processing system, direct the processing system to: identify a plurality of customers requesting a service able to be provided by at least one service provider of a pool of service providers and identify an availability of the at least one service provider to provide the service to the requesting customer during a travel route from a starting location to an ending location. For each available service provider, the program instructions direct the processing system to notify the service provider of the plurality of customers requesting the service, calculate a plurality of scores for each of the plurality of customers, generate respective guidance information regarding effects of accepting a booking with each of the plurality of customers and effects of rejecting the booking with each of the plurality of customers based on the plurality of scores, and communicate the guidance information to the service provider via a service provider user interface system suggesting at least one optimal action regarding the plurality of customers. The program instructions further direct the processing system to receive an input decision from the service provider regarding booking with the plurality of customers and communicate the input decision to be presented via a customer user interface system to the requesting customer.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a schematic diagram of system for booking service provider appointments according to some embodiments.

FIG. 2 is a block diagram of a server included in the system of FIG. 1 according to some embodiments.

FIG. 3 is a flow diagram illustrating a method for entering data into people and customer databases according to some embodiments.

FIG. 4 is a process flow diagram of an appointment booking method for setting service provider appointments with customers according to some embodiments.

FIG. 5 is a flow diagram illustrating steps of a sub-routine for calculating and presenting booking and waiting scores to a service provider according to one embodiment.

FIG. 6 is a block diagram for visually illustrating various features of the appointment booking method of FIG. 4 according to one embodiment.

FIG. 7 illustrates a computing system suitable for implementing the software technology disclosed herein, including any of the applications, architectures, elements, processes, and operational scenarios and sequences illustrated in the Figures and discussed below in the Detailed Description.

### DETAILED DESCRIPTION

Before any embodiments are explained in detail, it is to be understood that the embodiments described herein are not limited in their application to the details of construction and the arrangement of components set forth in the following description or illustrated in the following drawings. Embodiments may be practiced or carried out in various ways.

Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. The terms “connected” and “coupled” are used broadly and encompass both direct and indirect mounting, connecting, and coupling. Further, “connected” and “coupled” are not restricted to physical or mechanical connections or couplings, and may include electrical connections or couplings, whether direct or indirect. Also, electronic communications and notifications may be performed using any known means including direct or indirect wired connections, wireless connections, and combinations thereof. Also, functionality described as being performed by one device may be distributed among a plurality of devices.

It should also be noted that a plurality of hardware and software based devices, as well as a plurality of different structural components may be used to implement the embodiments set forth herein. In addition, it should be understood that embodiments may include hardware, software, and electronic components that, for purposes of discussion, may be illustrated and described as if the majority of the components were implemented solely in hardware. However, one of ordinary skill in the art, and based on a reading of this detailed description, would recognize that, in at least one embodiment, the electronic-based aspects of the embodiments may be implemented in software (e.g., stored on non-transitory computer-readable medium) executable by one or more electronic processors.

Technology is disclosed herein that allows for booking mobile service provider appointments. The service provider is notified of potential bookings and is provided guidance information regarding the benefits of accepting a potential booking or waiting for another opportunity.

A technical effect provided by the technology disclosed herein is the ability of a service provider to receive guidance containing information to help the service provider decide whether to accept a proposed booking or to wait for a better opportunity with a different potential customer.

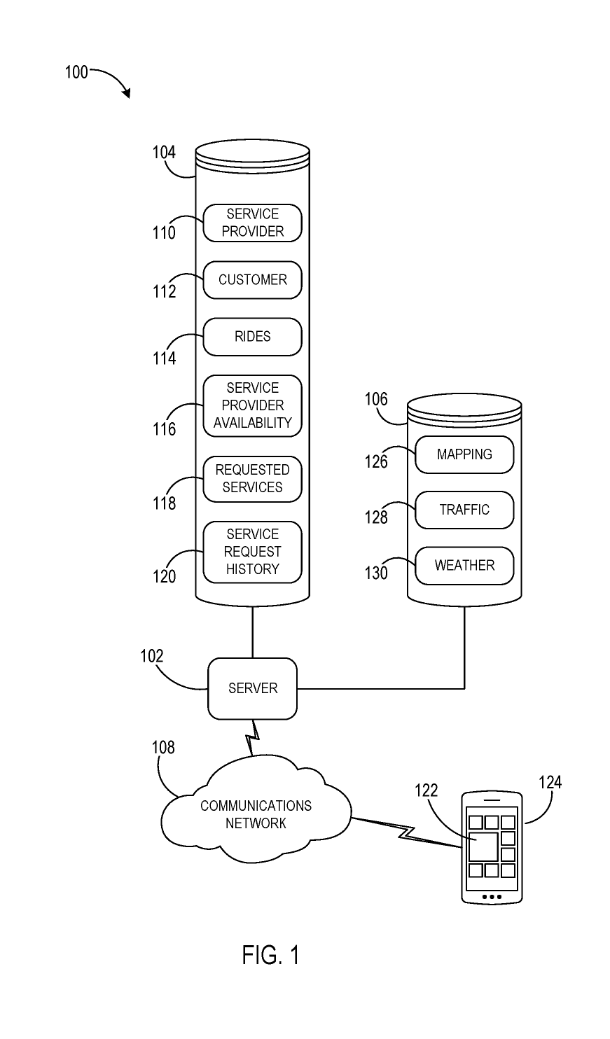

FIG. 1 schematically illustrates a system 100 for booking service provider appointments according to some embodiments. As illustrated in FIG. 1, the system 100 includes a computer or server 102 and one or more databases, such as one or more local databases 104, one or more external databases external database 106, or a combination thereof. Each database may be a database housed on a suitable database server communicatively coupled to accessible by the server 102 and may be a part of a cloud-based database system. Also, it should be understood that, in some embodiments, the server 102 and the databases 104, 106 (or portions thereof) may reside on the same physical machine or in the same data center.

When a local database 104 is included in the system 100, the local database 104 may be located in the same location as the server 102 and may communicate with the server 102 over a wired or wireless connection, which may be a direct connection or an indirect connection over a communications network. Alternatively, database 104 may be located remotely from the server 102 and may communicate with the server 102 over a wired or wireless connection, directly or indirectly connected over a communications network. When an external database 106 is included in the system 100, the external database 106 may be located remotely from the server 102, and the server 102 is communicatively coupled to the external database 106 via a communications network 108. The communications network 108 may be implemented using a wide area network, such as the Internet, a local area network, such as a Bluetooth™ network or Wi-Fi, a Long Term Evolution (LTE) network, a Global System for Mobile Communications (or Groupe Special Mobile (GSM)) network, a Code Division Multiple Access (CDMA) network, an Evolution-Data Optimized (EV-DO) network, an Enhanced Data Rates for GSM Evolution (EDGE) network, a 3G network, a 4G network, and combinations or derivatives thereof.

It should also be understood that the system 100 is provided as an example and, in some embodiments, the system 100 may include additional components. For example, the system 100 may include multiple servers 102 and multiple databases 104, 106 or a combination thereof.

In some embodiments, as illustrated in FIG. 1, the local database 104 and the external database 106 electronically store or access service provider data, rider data, rides data, service provider availability data, requested services data, service request history data, mapping data, and traffic data. It should be understood that, in some embodiments, the data stored in the databases 104, 106 may be distributed among multiple databases that communicate with the server 102, and, optionally, each database may store specific data used by the server 102 as described herein. For example, in some embodiments, the local database 104 may be distributed as a service provider database 110, a customer database 112, a rides database 114, a service provider availability database 116, a requested services database 118, and a service request history database 120, or a combination thereof, which may be included in a common database server or separate database servers, included in the server 102, or a combination thereof. Furthermore, while particular databases are illustrated as pertaining to either the local database 104 (e.g., databases 110-120) or the external database 106 (e.g., databases 126-130), embodiments of the invention include providing any of the databases 110-120 and 126-130 in either or both of the local and external databases.

The service provider data in the service provider database 110 accessible, for example, via a portal or application 122 where the service providers may register new accounts and update their information. The application 122 may be accessed, for example, by a mobile communication device 124. The service provider data may include a list of service providers (i.e., people) registered in the system with their type of service (e.g., manicurist, consultant, teacher, and the like), their service products (e.g., types of products or services delivered), duration times to perform their service products (e.g., minimum and maximum times), their product rates, their home location, preferred working hours, and service requirements (e.g., types of vehicles required for providing the service such as, for example, a breakfast provider requiring the availability of a breakfast vehicle). Additionally, the service providers may submit images of their work, professional qualifications, and references, and the like to the service provider database 110. In some cases, the service providers may have to be vetted in order to sign up for the booking service. The service providers may be reviewed and ranked by clients or users of their services, who access the service provider database 110 to provide such details. The review of the service provider may tell future clients how much to trust a given service provider's work.

The customer data in the customer database 112 may include clients/customers registering into the database 112 to be able to sign up for receiving the services from the providers in the service provider database 110. Customers may register their identity, payment instruments, the services desired, and the like. Like the service providers, the customers may be reviewed and ranked by the service providers who provided their services to respective. The service provider's review may tell future clients how much to trust a given service provider's work.

The rides data in the rides database 114 contains a list of requested rides of customers wishing to travel from one location to another location and a list of rides in progress. The rides in progress may contain data detailing which customers are in which modes of transportation, the current location of the customer, the starting destination, the target destination, the travelling route between the starting and target destinations, and how much time the current journey has left. In some implementations, this database 114 may be maintained by another company such as a taxi company, a ride sharing company, a car rental company, a car sharing company, and the like. In particular, the services provided by the service provider may be confidential in nature, and privacy between the customer and service provider is desired. Such privacy may be achieved in chauffeured rides (e.g., taxi, ride share, etc.) if a privacy screen provides a barrier between the driver in the front and the customer and service provider in the back. More common, however, may be privacy ensured by the customer and service provider being the only ones in the car. For example, the customer may be the driver while the service provider rides along to provide a non-contact service (e.g., consultation, coaching, language or singing tutor, etc.). In the case where the service requires contact (e.g., manicure, massage, etc.) or where focus and attention toward the service provider is beneficial, a self-driving car provides a viable venue in which to perform the service in privacy.

The service provider availability database 116 contains service provider availability information about the current status of each service provider. The current status may provide information detailing whether the service provider has accepted a client, how long the service provider has left with the current client, the service provider's current location and route, whether the service provider is available now for a different client, and whether the service provider will be available once the appointment with the current client is finished.

Requested service data in the requested services database 118 contains a list of the services requested by the customers in the customer database 112 and allows the customers to identify whether the service is requested for the next available opportunity or whether the service is requested for a future date/booking.

The service request history data in the service request history database 120 containing previous times, dates, and locations that a particular type of service was requested. For example, this database 120 may indicate that customers starting in a given geographical area in New York have a 10% chance of requesting a manicurist service during Friday rush-hours, compared with a 2% overall all-time all-location average.

Mapping data from a mapping database 126 may include road layouts and named destinations. In one embodiment, mapping database 126 may be retrieved from one or more public or private external databases 106 or services as shown. In another embodiment, mapping database 126 may be locally accessible by server 102.

The traffic data in a traffic database 128 may include current traffic conditions covering the service provider's area. Traffic data may be accessed, in one embodiment, from public or private external databases 106 or services as shown or from a traffic database 128 locally accessible by server 102. In other cases, a combined service offering ‘route times’ and ‘suggested routes from A to B’ may be leveraged that incorporates both actual/predicted traffic times and distances and routes.

The weather data in a weather database 130 may include current and forecasted weather conditions covering the service provider's area. Weather data may be accessed, in one embodiment, from public or private external databases 106 or services as shown or from a traffic database 128 locally accessible by server 102.

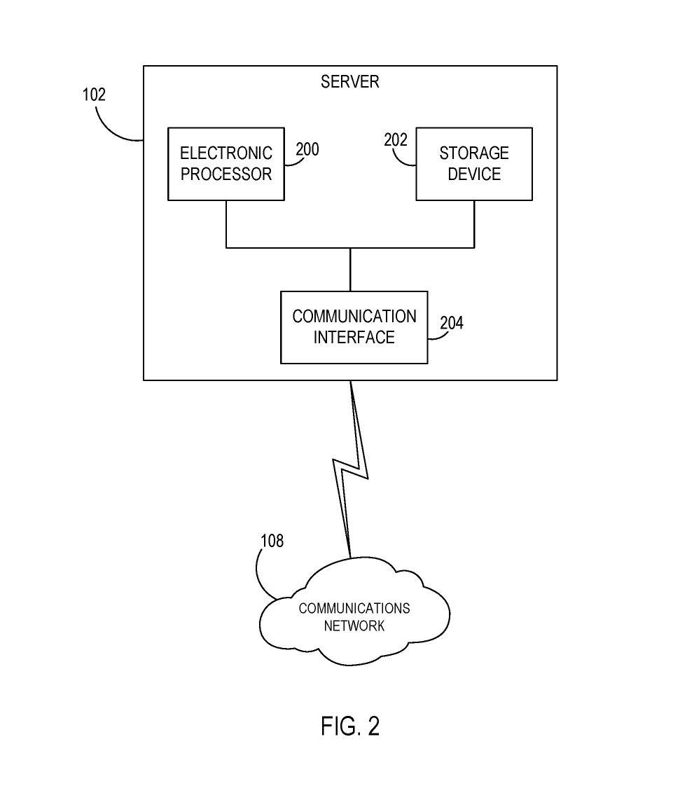

FIG. 2 schematically illustrates the server 102 in more detail. As illustrated in FIG. 2, the server 102 includes an electronic processor 200 (e.g., a microprocessor, application-specific integrated circuit (ASIC), or another suitable electronic device), a storage device 202 (for example, a non-transitory, computer-readable storage medium), and a communication interface 204, such as a transceiver, for communicating over the communications network 108 and, optionally, one or more additional communication networks or connections. It should be understood that the server 102 may include additional components than those illustrated in FIG. 2 in various configurations and may perform additional functionality than the functionality described in the present application. Also, it should be understood that the functionality described herein as being performed by the server 102 may be distributed among multiple devices, such as multiple servers and may be provided through a cloud computing environment, accessible by components off the system 100 via the communications network 108.

The electronic processor 200, the storage device 202, and the communication interface 204 included in the server 102 communicate over one or more communication lines or buses. The electronic processor 200 is configured to retrieve from the storage device 202 and execute, among other things, software related to the control processes and methods described herein. For example, the methods and flow diagrams described as being performed by the server 102 and, in particular, the electronic processor 200. However, it should be understood that in some embodiments, portions of the methods and flow diagrams may be performed by other devices, including for example, the mobile communication device 124.

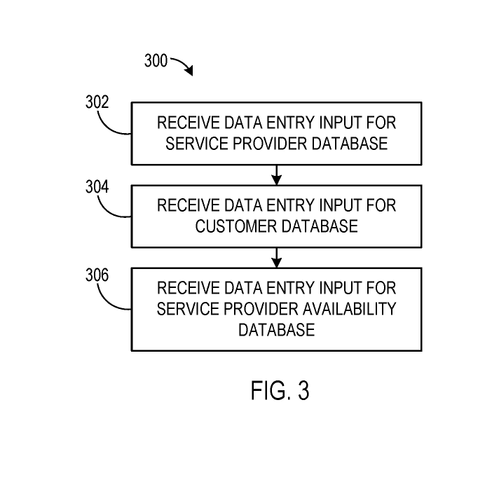

FIG. 3 is a flow diagram illustrating a method 300 for entering data into the service provider, customer, and service provider availability databases 110, 112, 116 according to some embodiments. At block 302, a service provider may register his services as described above. For example, the service provider may access the service provider database 110 to enter or update data regarding his service products, duration times, product rates, working areas, and preferred working hours.

The customers may enter data into the customer database 112 at block 304. The customers may separately register themselves in the system 100. Alternatively, customer data for the customer database 112 may be retrieved from the database of another company. For example, a customer or rider database from a ride share company or the like may be used to access customer information. The customer database 112 includes a record for all customers, whether or not the customer is actively requesting a ride, already in a ride, or awaiting a ride. The customer may update his list of desired services to indicate that one or more services is requested as soon as possible such as in the next ride. Alternatively, the customer may indicate that one or more services are merely to be held in a favorites list or wish list for another time and to not be requested for the next ride.

At block 306, the service provider may enter data into the service provider availability database 116 to indicate that he is available to provider services or is no longer available. While the service provider database 110 may include information regarding the service provider's preferred working hours, the service provider availability database 116 contains the currently active/inactive service providers.

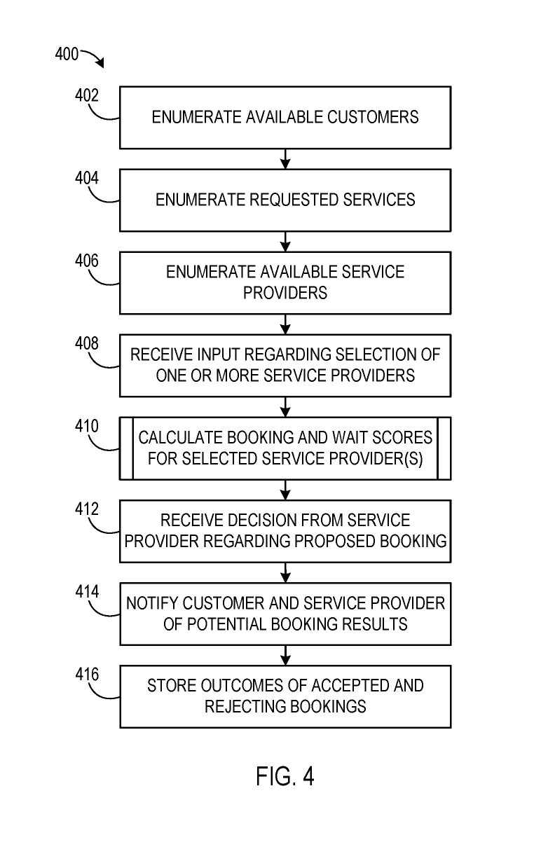

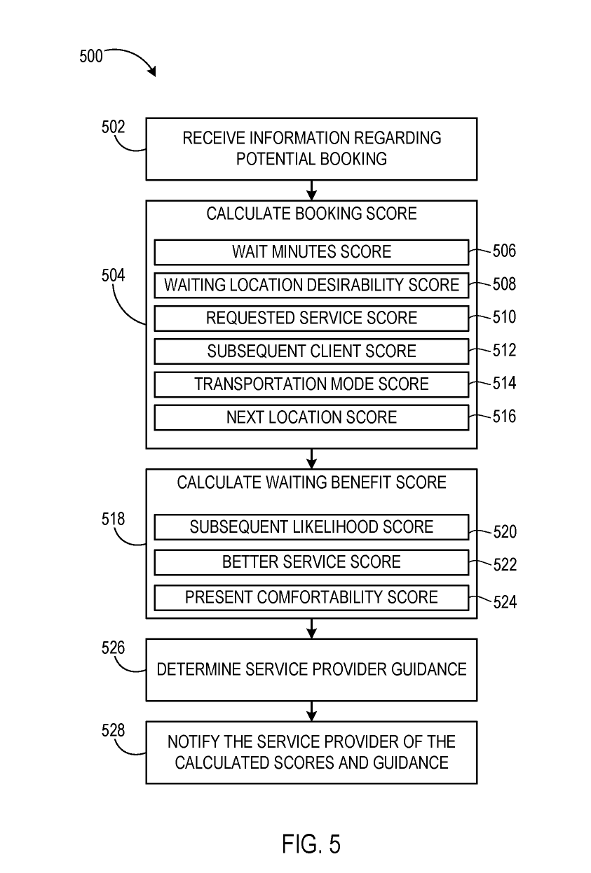

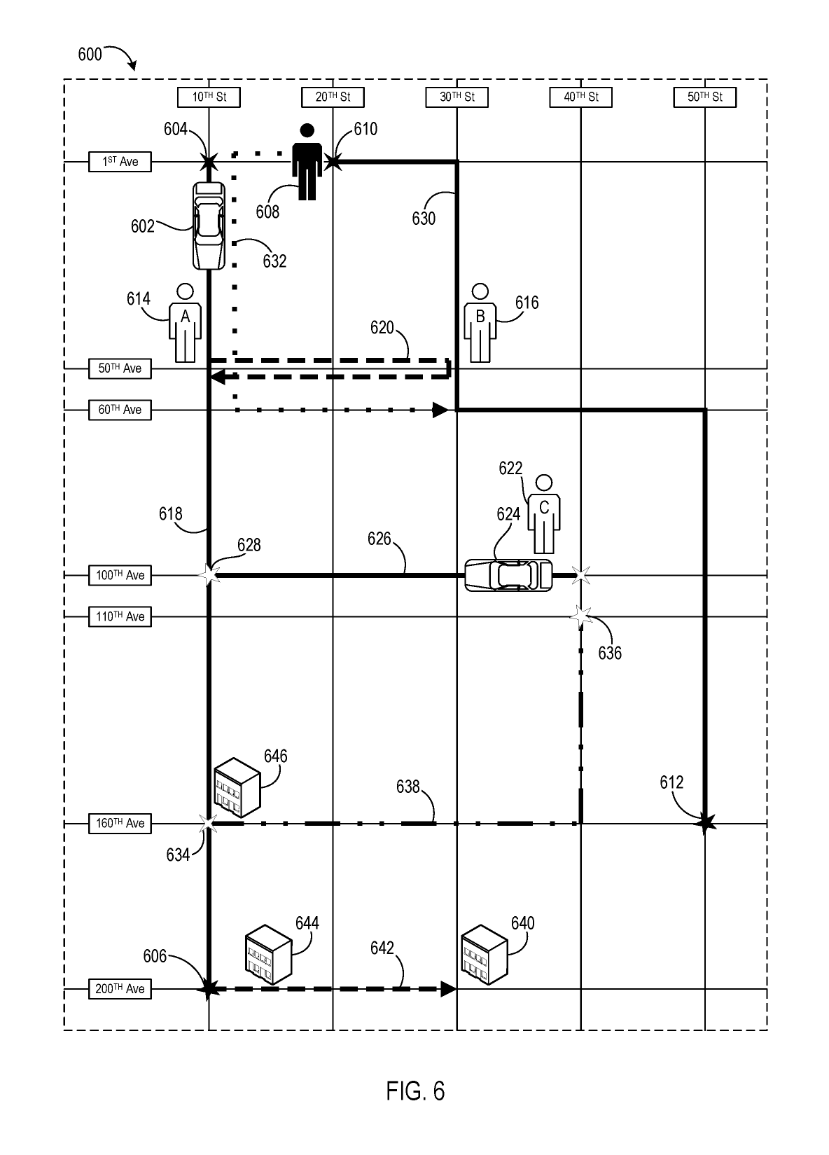

FIG. 4 is a flow diagram illustrating steps of an appointment booking method 400 for setting service provider appointments with customers, performed by the server 102 according to some embodiments. FIG. 5 is a flow diagram illustrating steps of a sub-routine 500 of method 400 for calculating and presenting booking and waiting scores to a service provider, performed by the server 102 according to some embodiments FIG. 6 is a block diagram 600 beneficial for visually illustrating various features of the appointment booking method 400 described herein. Reference numerals in the 400s refer to the steps illustrated in FIG. 4, reference numerals in the 500s refer to the steps illustrated in FIG. 5, and reference numerals in the 600s refer to the enumerated objects illustrated in FIG. 6.

Method 400 begins at block 402 by enumerating available customers. In this step, the rides database 114 may be accessed to retrieve a list of customers wishing to travel from one location to another and who have not yet begun their travel and to retrieve a list of rides in progress in which customers have begun their travel in their selected mode of transportation (e.g., taxi company, a ride sharing company, a car rental company, a car sharing company, bus, tram, metro, and the like). In addition, the other data in the rides database 114 may also be accessed such as the starting and target destinations, the traveling route, the traveling time, whether the customer is already en route, and the like. The available customers are ones who are not busy with a different service provider for the same or different service.

For example, a customer 602 already en route from a start destination 604 to a final or target destination 606 is not busy with a service provider. Another customer 608 waiting to travel from a second start destination 610 to a second target destination 612 is also not busy with a service provider. Both customer 602 and customer 608 are available customers. If, for example, customer 602 were instead with a service provider, customer 602 would not be available.

At block 404, the requested services from the available customers are enumerated. For the customers both en route and those still waiting to travel, their respective information from the customer database 112 regarding the services (e.g., manicure, consultation, and the like) they wish to have provided by a service provider may be retrieved. In one embodiment, it is possible for the customer to identify a desired service corresponding with his profile in the customer database 112 as being a requested service for the immediate or proximate traveling period. In addition or alternatively thereto, the customer may choose from a list of available services during the booking of the transportation mode. The list of services, in some embodiments, may be determined by analyzing the types of services that are on offer from a list of all available service providers in the service provider availability database 116. Available services may be determined by analyzing which service providers are or will be available and able to meet with the customer within a given time (e.g., 15 minutes) of the customer's requested ride. The given time may be configured by the customer to indicate how much time he allows to wait for the service.

For example, the service requested by customer A 602 may be provided by either service provider A 614 or service provider B 616, each able to meet with customer A 602 within the request parameters. In addition, the service requested by customer B 608 may also be provided by either service provider A 614 or service provider B 616. These requested services are populated into the requested service data in the requested services database 118.

In another illustration, customers wishing to be served by the same service provider where the service provided does not require confidentiality may be enumerated. For example, customers wishing to carpool to a similar location or to locations along a carpool route who want breakfast service in a meal van or bus from a common service provider may identified in the requested service data of the requested services database 118.

Method 400 continues at block 406 by enumerating available service providers. In this step, the service provider availability database 116 may be accessed to retrieve a list of available service providers from the pool of all service providers, their location, the duration of their services, and the like. Block 406 includes identifying a subset of service providers who are within time and distance parameters the customer is willing to spend the travelling distance and time. For example, out of 20,000 service providers within a region, 842 are in a proximate area to the travel route. These 842 service providers may be determined to be proximate or nearby by being within a certain distance or within a certain number of minutes' ride away. A threshold for the maximum distance and/or number of minutes may be defined by the system (e.g., a maximum of one hour ride away) or by the service provider's personal preferences set up in the service provider database 110. The other non-proximate service providers over the maximum distance and/or time thresholds are discounted and considered unavailable. For simplicity, only two available service providers (i.e., service provider A 614 and service provider B 616) are illustrated. Then, the projected route 618 of the rider/customer 602 is calculated based on mapping and traffic predictions from mapping and traffic databases 126, 128 along the intended route 618 from start destination 604 to target destination 606. An initial route time is calculated based on the customer 602 travelling without receiving any service.

If the customer expresses interest in a particular service, a set of options may be presented to the customer. For example, the customer may opt to book a taxi or ride even if no service provider is available for that trip, to wait until a ride is available with that service (a projected time to wait for such a service to be available may be shown to the customer), or to use a ride immediately without the service and instead make a request for a future trip on the same route to contain the service. The customer may express a desire for different classes or types of service (each with different price points). This request is then saved in the requested services database 118.

In an example, the calculated route 618 may indicate that at 5:40 pm, customer A 602 will travel along 10th St. from start destination 604 to target destination 606 and arrive at about 6:15 pm. Each of the locations of the subgroup of service providers is also calculated. For service providers who aren't actively giving services, their current location may be used. For example, service provider A 614 is identified as being located at the intersection of 10th St. and 50th Ave. As such, service provider A 614 is already alongside route 618. The location of service provider B 616 is identified as the intersection of 50th St. and 30th Ave. at 5:40 pm. However, at 5:45 pm, service provider B 616 could be at the intersection of 10th St. and 50th Ave. to be picked up by customer A 602 if needed.

For each service provider (e.g., service provider A 614 and service provider B 616), the closest point of intersection with the route 618 is calculated. A time to intersect with the service provider delay may be calculated as well as a total route delay caused by the entire route 618 being altered due to the need to wait for the service provider after arriving at a particular meeting or intersection location or due to the route 618 taking a detour to meet the service provider may be calculated in terms of minutes of delay beyond the initial calculated route time. For example, if customer A 602 is required to wait five minutes for the designated service provider to arrive at a particular meeting or intersection location, the time to intersect with the service provider delay would indicate “5 minutes”. In addition, the total route delay could also indicate “5 minutes” if no route detour were taken. In another example, if the closest point of intersection is a half mile detour away from the route 618 and it takes ten minutes to drive the first direction of the detour, the time to intersect with the service provider delay would be “10 minutes”, but the total route delay to the route would be calculated as “20 minutes” (e.g., 10 minutes to take a detour to pick the service provider up and another 10 minutes to get back to the original route). Any point of intersection or crossing of paths between the customer requesting the service and a service provider who is actively giving a service to another client is not counted if the service provider will not be finished with the prior client at the time of intersection.

In one example, service provider A 614 is currently located at the intersection of 10th St. and 50th Ave. and is available to provide the service that customer A 602 requested. Since service provider A 614 is already intersecting with the calculated route 618 and is at the intersection before customer A 602, the time to intersect with the service provider delay may be negligible, and no delay to the route 618 is reported. Alternatively, service provider B 616 is at the intersection of 30th St. and 50th Ave., and it would take five minutes of detour 620 to travel from 10th St. to 30th St. at 50th Ave. to pick service provider B 616 up and another five minutes to return. In this case, the time to intersect with the service provider delay may be calculated as well as a total route delay would indicate “5 minutes”, and the total route delay would be “10 minutes”.

Additionally, a third service provider (e.g., service provider C 622) may already actively be taking a ride along a given route 626. Service provider C 622 may be travelling with a customer (e.g., customer C 624) toward a target destination 628 at the intersection of 10th St. and 100th Ave. The availability of service provider C 622 is stored in the service provider availability database 116, which contains the start time of taking the ride with customer C 624 and the end time. The projected time of arrival at target destination 628 is before the arrival of customer A 602 at the same location. Therefore, even though service provider C 622 is currently with a customer and is also currently unavailable, the status of service provider C 622 will change to available before the arrival of customer A 602 at the intersection. Accordingly, service provider C 622 may also be enumerated as an available service provider within the list of available service providers for customer A 602 to choose. If a service provider were to start the journey with customer A 602 at start destination 604 and the service takes 30 minutes to administer and the traffic time predictions are such that the service will be fully administered by 110th Ave., the availability of that service provider in the service provider availability database 116 may reflect that the service provider is available at 6:10 pm on 110th Ave., 6:20 pm on 160th Ave., and the like were the service provider to ride with customer A 602 all the way to target destination 606. The availability of the service provider in the service provider availability database 116 may also reflect an unavailable state earlier at 6:00 pm on 60th Ave. Accordingly, a potential customer with a starting trip location 634 at the intersection of 10th St. and 160th Ave. and travelling to a final destination 636 along route 638 may wait for the service provider to arrive at location 634 if the potential customer arrives first, or the service provider may exit the vehicle with customer A 602 and wait for the potential customer at location 634 if the service provider arrives first.

In another example, a projected route 630 for waiting customer B 608 intersects with service provider B 616, who is currently located at the intersection of 30th St. and 50th Ave. and who is available to provide the service that customer B 608 requested. Since service provider B 616 is already intersecting with the calculated route 618 and is at the intersection before the arrival of customer B 608, the time to intersect with the service provider delay may be negligible, and no delay to the route 630 is reported. Alternatively, service provider A 614 is at the intersection of 30th St. and 50th Ave., and it would take three minutes of detour 632 to travel from 20th. St. to 10th St. along 1st Ave. to pick service provider A 614 up and another three minutes to travel from 10th St. to 20th. St. along 50th Ave. The remaining portions of detour 632 correspond with travel times along the same respective distances of route 630 and do not need to be included in the delay calculations. In this case, the time to intersect with the service provider delay may be calculated as well as a total route delay would indicate “3 minutes”, and the total route delay would be “6 minutes”.

Furthermore, a portion of the total route delay may be calculated for the end of the calculated route 618 if the duration of the service provided by the service provider indicates that the service will not be completed by the time the target destination 606 is reached. For example, if the time estimated for providing the service is longer than the time from service provider pickup to arrival at the target destination 606, any extra time needed to complete the service once the target destination 606 is reached may be added to calculations of total route delay. Such extra time needed at the end of the ride, however, will typically add costs due to the need to hire the vehicle for a longer time than necessary to initially reach the target destination 606.

At block 408, method 400 receives an input from one of the requesting customers regarding the selection of one or more service providers satisfying the customer's criteria. At block 410, a sub-routine 500 for calculating and presenting booking and waiting scores to a selected service provider. Sub-routine 500 notifies the service provider of the potential booking and provides guidance to allow the service provider to look and see what the system recommends for next steps.

Sub-routine 500 includes, at block 502, receiving the information regarding the potential booking or requested service due to the service provider being selected at block 408. A booking score is calculated at block 504 that includes calculating a plurality of sub-scores and weighting and combining them to determine the booking score. A wait minutes sub-score 506 is calculated based on the number of minutes to be waited until the service provider can provide the service to the requesting customer. If the service provider is waiting and does not currently have a client, the number of wait minutes is the time until that client/customer and service provider will meet. Long wait times may be disadvantageous to the service provider since income may be unable to be derived while the service provider is waiting. If the service provider is currently providing service to another customer, number of wait minutes is the time from which the service provider will be finished with the current customer until the meeting with the next customer (e.g., the requesting customer). This sub-score 506 is in calculated in minutes and may be normalized and weighted.

A waiting location desirability sub-score 508 is additionally calculated. In the scenario where the service provider will need to wait for the potential customer, the desirability of the location where the service provider will be waiting is used to calculate this sub-score 508. The location desirability my generally be higher for locations (e.g., airports or hotel reception areas) friendly to waiting service providers and that provide shelter and comfortable places to wait. High desirability locations may help the service provider to feel safe and secure while waiting, and the types of locations and specific locations may be stored with the service provider's data in the service provider database 110. Low desirability locations may be, for example, street corners in the rain or in other undesirable weather, locations where the service provider does not feel safe and/or comfortable, and the like.

A requested service sub-score 510 is also calculated and may be higher for services the service provider prefers to provide. Such services may be services that have higher earning potential for the service provider, premium services, services that have a higher satisfaction for the service provider, services that offer the better benefit to the potential customer, and the like. The preferred services may be stored with the service provider's data in the service provider database 110.

A subsequent client score 512 is calculated based on the likelihood of getting a subsequent customer if the current potential booking were to be accepted by the service provider. The calculation of this score 512 includes determining the projected end time and location of the route (e.g., route 618) for the potential customer and determining the projected end time of the service provided and the location where the service provider and potential customer will be (e.g., the service provider will be done when the route still has a mile remaining). At incremental points along the final portion of the route after the service would be completed, a set of best drop off points is determined (e.g., locations within a 15-minute radius of the incremental points). For example, there may be a hotel 640 that is a 10-minute detour 642 from the route's ending location 606. This hotel 640 may have historically logged a better-than-average service request rate for future services than other locations in the area. The subsequent client score 512 may be computed from factors including deviation time, safety and comfort of drop-off location, the historical likelihood of requests for services near that location for that time of day, and the weather and waiting conditions at that location (e.g., waiting outdoors vs. indoors).

A transportation mode sub-score 514 is calculated based on the type of transportation to be used by the requesting customer. If the customer will be traveling in a vehicle with little to no privacy, the transportation mode sub-score 514 may have a low value indicating that there is a low expectation of privacy. However, for high-privacy modes of transportation such as a self-driving car or another type of vehicle where the requesting customer and the service provider will be the only occupants, the transportation mode sub-score 514 will reflect a high value indicating a high expectation of privacy.

A next location score 516 is also calculated. If the service provider has an advance booking at a pre-determined location or a desire to go to a particular next location (e.g., go home at the end of a day), the next location score 516 for the current potential booking is calculated based on the ability of the potential booking to deliver the service provider to the desired location at the end of providing the requested service. For example, at point along the route after the service is completed, the distance of one or more detours to that desired location influences this score 516. Shorter detours have a greater impact on increasing this score 516 than longer detours. Also, historical behaviors of the potential customer to allow such detours may also be taken into consideration.

The sub-scores 506-516 are weighted and combined to provide the booking score 504.

At block 518, sub-routine 500 calculates a waiting benefit score that indicates the benefits of not choosing the current potential service request but waiting for a subsequent request instead. A subsequent likelihood sub-score 520 is calculated based on the likelihood of a new, subsequent client requesting a service to be received at or near the service provider's current location. This looks at the historical frequency of requests for the types of services provided by the service provider within a walking distance radius from the service provider's current location or estimated future location in future time periods. A low subsequent likelihood sub-score 520 may result, for example, from a potential booking that earns money during the trip but leaves the service provider in an area with a low historical record of acquiring work when the trip finishes.

A better service sub-score 522 is calculated based on the likelihood of a subsequent client to request a higher-paid service. The subsequent request may be at the current service provider location or at a different location. If the potential meeting location of the subsequent client is not at the service provider's current location, it may still be more beneficial for the service provider to travel to the potential meeting location than to accept and perform the current requested service. The better service sub-score 522 reflects the benefits of waiting for potential future bookings vs. accepting the current request.

A present comfortability sub-score 524 is also computed and is based on the comfortability of the service provider to continue to wait at the current location and also based on the comfortability of travelling with the potential customer to the customer's target destination. Factors for this score include the service provider's safety and comfort of the current location vs. the results of accepting the requested booking. The higher this sub-score 524, the more beneficial it is for the service provider to remain at the current location and decline the requested booking.

The sub-scores 520-524 are weighted and combined to form the waiting benefit score 518.

At block 526, guidance for the service provider is determined. The guidance or recommendation may be determined based on the calculated scores 504, 518 and sub-scores 506-516, 520-524 and how they relate to various thresholds. In one embodiment, if the scores 504, 518 are within a respective threshold, sub-routine 500 performs an analysis to predict whether the service provider may have significantly better outcomes by travelling to a particular destination that is not within walking distance (e.g., by taxi). For example, historical data may show that there is a high request rate by customers for highly-paid services with a low tolerance for more than 10 minutes' deviation from their route. As such, the location of where to meet such a customer in order to reduce route deviation may be determined and suggested to the service provider as part of the guidance since it may be in the service provider's interest to travel toward that location even if such travel costs must be paid personally. In another embodiment, if the scores 504, 518 are within a different respective threshold, sub-routine 500 may inform the service provider that the requested service is the optimal one to result in the service provider arriving at or near a per-determined location or arriving at a favorable location for future bookings. In another embodiment, the service provider may be guided to rideshare with another passenger who is likely to head in the direction of favorable client pick-up locations, even if that passenger does not want the service provider's services.

A low waiting location desirability sub-score 508 may cause sub-routine 500 to determine higher-desirability locations. For example, rather than waiting in an unsheltered location after reaching the target destination 606, a nearest high-desirable location 644 may be suggested to the service provider that is within a walking threshold (e.g., 15 minutes) from target destination 606. Additionally, a different location 646 prior to reaching the target destination 606 that has a shorter walking distance may be suggested together with the location and drop-off information to reach it. Location 646 may be suggested by analyzing that the service provided to customer A 602 along route 618 will end before reaching location 646.

At block 528, the service provider may be notified of the calculated scores 504, 518 and sub-scores 506-516, 520-524 and the guidance recommendations sorted in a ranked order. In this step, the notification may be communicated for presentation via a user interface system accessible to the service provider. The service provider may also be notified of the key insights into the requested booking (e.g., what is the money earned, what are best drop-off points, where to travel when the service is completed (e.g., to hotel 640 along detour 642 after the customer has reached his final destination 606); for a guidance recommendation to wait or to travel elsewhere for a future service request, where are the recommended travel destinations and/or wait points).

Method 400 receives input of a decision from each service provider regarding the proposed booking at block 412. The potential customer and the service provider are notified at block 414 of the results of the potential booking. In this step, the notification may be communicated for presentation via a user interface system accessible to the potential customer. In one embodiment, the proposed booking, when sent to the service provider, allows the service provider to accept the booking and perform the requested service without further input from the potential customer. In this case, the input received from the service provider may be the service provider's acceptance of the proposed booking. Accordingly, the potential customer and the service provider are then notified of the arrangements needed to satisfy the agreed booking (e.g., meeting location, service duration, detour(s) required, drop-off locations required, and the like).

In another embodiment, the proposed booking, when sent to the service provider, notifies the service provider of the potential booking, but if the service provider desires to move forward, additional discussion and/or agreements are handled by putting the potential customer and service provider in contact with each other to work out the details. In this case, the input received from the service provider may be the service provider's willingness to communicate with the potential customer to find out more information, resolve issues, finalize details of the potential booking, and the like. For example, the service provider may communicate to the potential customer about being dropped at location X; the potential customer may see the surplus travelling cost based on the drop-off point for discussion with the service provider, and the cost may be mutually decided to be shared by both; etc. Accordingly, the potential customer and the service provider are notified of the potential match and they are provided a way to get in contact with each other (e.g., telephone number information, email information, direct communication via the booking application, and the like).

The system 100 may provide multiple potential bookings to the service provider, and a ranked list of such potential bookings in an order of desirability based on their respective booking and waiting benefit scores may be determined for each request as value of fulfilling that request. The ranked list is displayed to the service provider together with guidance regarding the optimal potential booking to accept to help the service provider make a decision about which potential booking to accept.

At block 416, the successful bookings together with data regarding pick-up/drop-off locations, times, routes, detours, services rendered, prices, and other relevant information is stored in the service request history database 120. Reviews for service provider and the client may also be recorded in the service request history database 120 together with being stored in the personal record of the service provider or customer in the service provider database 110 and customer database 112.

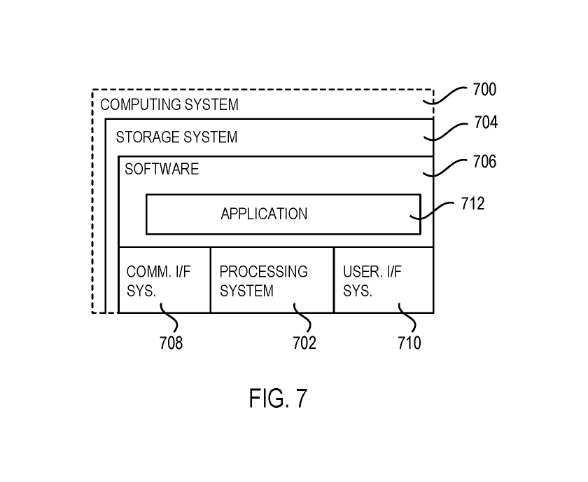

FIG. 7 illustrates a computing system 700, which is representative of any system or collection of systems in which the various applications, services, scenarios, and processes disclosed herein may be implemented. Examples of computing system 700 include, but are not limited to, desktop computers, laptop computers, tablet computers, computers having hybrid form-factors, mobile phones, smart televisions, wearable devices, server computers, blade servers, rack servers, and any other type of computing system (or collection thereof) suitable for carrying out the application launching operations described herein. Such systems may employ one or more virtual machines, containers, or any other type of virtual computing resource in the context of supporting enhanced group collaboration.

Computing system 700 may be implemented as a single apparatus, system, or device or may be implemented in a distributed manner as multiple apparatuses, systems, or devices. Computing system 700 includes, but is not limited to, processing system 702, storage system 704, software 706, communication interface system 708, and user interface system 710. Processing system 702 is operatively coupled with storage system 704, communication interface system 708, and user interface system 710.

Processing system 702 loads and executes software 706 from storage system 704. Processing system 702 may be or reside on, for example, server 102. Software 706 includes application 712, which is representative of a software application executed by a processor and programmed to execute the methods described herein. When executed by processing system 702 to facilitate and guide pre-booking requests, application 712 directs processing system 702 to operate as described herein for at least the various processes, operational scenarios, and sequences discussed in the foregoing implementations. Computing system 700 may optionally include additional devices, features, or functionality not discussed for purposes of brevity.

Referring still to FIG. 7, processing system 702 may comprise a micro-processor and other circuitry that retrieves and executes software 706 from storage system 704. Processing system 702 may be implemented within a single processing device, but may also be distributed across multiple processing devices or sub-systems that cooperate in executing program instructions. Examples of processing system 702 include general purpose central processing units, application specific processors, and logic devices, as well as any other type of processing device, combinations, or variations thereof.

Storage system 704 may comprise any computer readable storage media readable by processing system 702 and capable of storing software 706. Storage system 704 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations, storage system 704 may also include computer readable communication media over which at least some of software 706 may be communicated internally or externally. Storage system 704 may be implemented as a single storage device, but may also be implemented across multiple storage devices or sub-systems co-located or distributed relative to each other. Storage system 704 may comprise additional elements, such as a controller, capable of communicating with processing system 702 or possibly other systems.

Software 706 in general, and application 712 in particular, may be implemented in program instructions and among other functions may, when executed by processing system 702, direct processing system 702 to operate as described with respect to the various operational scenarios, sequences, and processes illustrated herein. For example, application 712 may include program instructions for facilitating service provider booking procedures such at that described in methods 400 and 500.

In particular, the program instructions may include various components or modules that cooperate or otherwise interact to carry out the various processes and operational scenarios described herein. The various components or modules may be embodied in compiled or interpreted instructions, or in some other variation or combination of instructions. Software 706 may include additional processes, programs, or components, such as operating system software, virtual machine software, or other application software, in addition to or that include application 712. Software 706 may also comprise firmware or some other form of machine-readable processing instructions executable by processing system 702.

In general, application 712 may, when loaded into processing system 702 and executed, transform a suitable apparatus, system, or device (of which computing system 700 is representative) overall from a general-purpose computing system into a special-purpose computing system customized to enhance entity classification operations. Indeed, encoding application 712 on storage system 704 may transform the physical structure of storage system 704. The specific transformation of the physical structure may depend on various factors in different implementations of this description. Examples of such factors may include, but are not limited to, the technology used to implement the storage media of storage system 704 and whether the computer-storage media are characterized as primary or secondary storage, as well as other factors.

For example, if the computer readable storage media are implemented as semiconductor-based memory, application 712 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 708 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 710 may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 710. In some cases, the input and output devices may be combined in a single device, such as a display capable of displaying images and receiving touch gestures. The aforementioned user input and output devices are well known in the art and need not be discussed at length here.

User interface system 710 may also include associated user interface software executable by processing system 702 in support of the various user input and output devices discussed above. Separately or in conjunction with each other and other hardware and software elements, the user interface software and user interface devices may support a graphical user interface, a natural user interface, or any other type of user interface, in which a user interface to an application may be presented.

Communication between computing system 700 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well-known and need not be discussed at length here. In any of the aforementioned examples in which data, content, or any other type of information is exchanged, the exchange of information may occur in accordance with any of a variety of well-known data transfer protocols.

Certain inventive aspects may be appreciated from the foregoing disclosure, of which the following are various examples.

### Example 1

A computing apparatus comprising: one or more computer readable storage media; a processing system operatively coupled with the one or more computer readable storage media; and program instructions stored on the one or more computer readable storage media for booking service provider appointments that, when executed by the processing system, direct the processing system to at least: enumerate a set of customers requesting a service from a pool of service providers; identify a set of available service providers able to provide the service to a requesting customer of the set of customers; for a selected service provider of the set of available service providers: notify the selected service provider of a potential booking; calculate at least one score for the potential booking; based on the at least one score, generate guidance for the selected service provider regarding effects of the potential booking; and communicate the guidance to be presented via a service provider user interface system to the selected service provider; receive an input decision from the selected service provider regarding the potential booking; and communicate the input decision to be presented via a customer user interface system to the requesting customer.

### Example 2

The computing apparatus of Example 1 wherein, to calculate the least one score for the potential booking, the program instructions direct the processing system to: calculate a booking score indicative of a recommendation to accept the potential booking; and calculate a waiting benefit score indicative of a recommendation to reject the potential booking.

### Example 3

The computing apparatus of Examples 1-2 wherein, to calculate the booking score, the program instructions direct the processing system to calculate one of: a wait minutes sub-score based on a number of minutes to be waited until the selected service provider can provide the service to the requesting customer; a waiting location desirability sub-score based on a desirability of a location where the selected service provider will be waiting for the requesting customer; a requested service sub-score based on a rank of the service of the potential booking by the selected service provider; a subsequent client score based on a likelihood of getting a subsequent customer if the potential booking were to be accepted by the selected service provider; and a next location score based on an ability of the selected service provider to be delivered to a desired location at an end of providing the service.

### Example 4

The computing apparatus of Examples 1-3 wherein, to calculate the waiting benefit score, the program instructions direct the processing system to calculate one of: a subsequent likelihood sub-score based on a likelihood of a customer other than the requesting customer to request another service booking at or near a current location of the selected service provider; a better service sub-score based on a likelihood of a customer other than the requesting customer to request a higher-paid service; and a present comfortability sub-score based on a comfortability of the selected service provider to remain at the current location of the selected service provider.

### Example 5

The computing apparatus of Examples 1-4 wherein, to generate the guidance, the program instructions direct the processing system to predict one or more locations where the selected service provider may have an increased likelihood of booking a customer requesting a highly-paid service.

### Example 6

The computing apparatus of Examples 1-5 wherein, to generate the guidance, the program instructions direct the processing system to predict one or more locations where the selected service provider may have an increased comfortability level when waiting for potential customers.

### Example 7

A method for booking service provider appointments comprising: identifying a requesting customer seeking a service provided by a service provider; identifying an availability of the service provider to be able to provide the service to the requesting customer; if the service provider is available: notifying the service provider of a potential booking; calculating a plurality of scores for the potential booking; based on the plurality of scores, generating guidance for the service provider regarding effects of accepting the potential booking and effects of rejecting the potential booking; communicating the guidance to be presented via a service provider user interface system to the selected service provider; receiving an input decision from the service provider regarding the potential booking; and communicating the input decision to be presented via a customer user interface system to the requesting customer.

### Example 8

The method of Example 7 further comprising identifying a travel route of the requesting customer; and identifying the availability of the service provider based on a proximity of the service provider to the travel route.

### Example 9

The method of Examples 7-8 wherein generating guidance for the service provider comprises determining a desirability of the service provider to travel to a final destination of the travel route.

### Example 10

The method of Examples 7-9 wherein identifying the availability of the service provider comprises: identifying that the service provider is not available when the requesting customer begins traveling along the travel route; identifying that the service provider will become available at a destination along the travel route; and wherein notifying the service provider of the potential booking comprises notifying the service provider of the destination along the travel route as a meeting location with the requesting customer.

### Example 11

The method of Examples 7-10 further comprising identifying a detour from the travel route along which the requesting customer may travel in order to meet with the service provider.

### Example 12

The method of Examples 7-11 wherein generating guidance for the service provider comprises: determining a desirability of the service provider to accept the potential booking; and determining a desirability of the service provider to reject the potential booking.

### Example 13

The method of Examples 7-12 wherein determining the desirability of the service provider to accept the potential booking comprises determining one of: a wait minutes sub-score based on a number of minutes to be waited until the service provider can provide the service to the requesting customer; a waiting location desirability sub-score based on a desirability of a location where the service provider will be waiting for the requesting customer; a requested service sub-score based on a rank of the service of the potential booking by the service provider; a subsequent client score based on a likelihood of getting a subsequent customer if the potential booking were to be accepted by the service provider; and a next location score based on an ability of the service provider to be delivered to a desired location at an end of providing the requested service.

### Example 14

The method of Examples 7-13 wherein determining the desirability of the service provider to reject the potential booking comprises determining one of: a subsequent likelihood sub-score based on a likelihood of a customer other than the requesting customer to request another service booking at or near a current location of the service provider; a better service sub-score based on a likelihood of a customer other than the requesting customer to request a higher-paid service; and a present comfortability sub-score based on a comfortability of the service provider to remain at the current location of the service provider.

### Example 15

One or more computer readable storage media having program instructions stored thereon for allocating parking spaces in a parking lot, wherein the program instructions, when executed by a processing system, direct the processing system to at least: identify a plurality of customers requesting a service able to be provided by at least one service provider of a pool of service providers; identify an availability of the at least one service provider to provide the service to the requesting customer during a travel route from a starting location to an ending location; for each available service provider: notify the service provider of the plurality of customers requesting the service; calculate a plurality of scores for each of the plurality of customers; based on the plurality of scores, generate respective guidance information regarding effects of accepting a booking with each of the plurality of customers and effects of rejecting the booking with each of the plurality of customers; and communicate the guidance information to the service provider via a service provider user interface system suggesting at least one optimal action regarding the plurality of customers; receive an input decision from the service provider regarding booking with the plurality of customers; and communicate the input decision to be presented via a customer user interface system to the requesting customer.

### Example 16

The one or more computer readable storage media of Example 15 wherein the program instructions that direct the processing system to display the guidance information further direct the processing system to display an optimal ranked list of the plurality of customers from which to accept a booking.

### Example 17

The one or more computer readable storage media of Examples 15-16 wherein the program instructions that direct the processing system to display the guidance information further direct the processing system to display desirable drop-off locations for the available service provider after the service is calculated to be finished.

### Example 18

The one or more computer readable storage media of Examples 15-17 wherein the program instructions that direct the processing system to display the guidance information further direct the processing system to display transportation mode score indicating a desirability of the type of transportation to be used during a travel route by each of the plurality of customers.

### Example 19

The one or more computer readable storage media of Examples 15-18 wherein the program instructions further direct the processing system to calculate a higher transportation mode score for a high-privacy vehicle.

### Example 20

The one or more computer readable storage media of Examples 15-19 wherein the high-privacy vehicle comprises a self-driving car.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A computing apparatus comprising:
one or more computer readable storage media;
a processing system operatively coupled with the one or more computer readable storage media; and
program instructions stored on the one or more computer readable storage media for booking service provider appointments that, when executed by the processing system, direct the processing system to at least:
enumerate a set of customers requesting a service from a pool of service providers;
identify a set of available service providers able to provide the service to a requesting customer of the set of customers;
for a selected service provider of the set of available service providers:
notify the selected service provider of a potential booking;
calculate at least one score for the potential booking;
based on the at least one score, generate guidance for the selected service provider regarding effects of the potential booking; and
communicate the guidance to be presented via a service provider user interface system to the selected service provider;
receive an input decision from the selected service provider regarding the potential booking; and
communicate the input decision to be presented via a customer user interface system to the requesting customer.

2. The computing apparatus of claim 1 wherein, to calculate the least one score for the potential booking, the program instructions direct the processing system to:
calculate a booking score indicative of a recommendation to accept the potential booking; and
calculate a waiting benefit score indicative of a recommendation to reject the potential booking.

3. The computing apparatus of claim 2 wherein, to calculate the booking score, the program instructions direct the processing system to calculate one of:
a wait minutes sub-score based on a number of minutes to be waited until the selected service provider can provide the service to the requesting customer;
a waiting location desirability sub-score based on a desirability of a location where the selected service provider will be waiting for the requesting customer;
a requested service sub-score based on a rank of the service of the potential booking by the selected service provider;
a subsequent client score based on a likelihood of getting a subsequent customer if the potential booking were to be accepted by the selected service provider; and
a next location score based on an ability of the selected service provider to be delivered to a desired location at an end of providing the service.

4. The computing apparatus of claim 2 wherein, to calculate the waiting benefit score, the program instructions direct the processing system to calculate one of:
a subsequent likelihood sub-score based on a likelihood of a customer other than the requesting customer to request another service booking at or near a current location of the selected service provider;
a better service sub-score based on a likelihood of a customer other than the requesting customer to request a higher-paid service; and
a present comfortability sub-score based on a comfortability of the selected service provider to remain at the current location of the selected service provider.

5. The computing apparatus of claim 1 wherein, to generate the guidance, the program instructions direct the processing system to predict one or more locations where the selected service provider may have an increased likelihood of booking a customer requesting a highly-paid service.

6. The computing apparatus of claim 1 wherein, to generate the guidance, the program instructions direct the processing system to predict one or more locations where the selected service provider may have an increased comfortability level when waiting for potential customers.

7. A method for booking service provider appointments comprising:
identifying a requesting customer seeking a service provided by a service provider;
identifying an availability of the service provider to be able to provide the service to the requesting customer;
if the service provider is available:
notifying the service provider of a potential booking;
calculating a plurality of scores for the potential booking;
based on the plurality of scores, generating guidance for the service provider regarding effects of accepting the potential booking and effects of rejecting the potential booking;
communicating the guidance to be presented via a service provider user interface system to the selected service provider;
receiving an input decision from the service provider regarding the potential booking; and
communicating the input decision to be presented via a customer user interface system to the requesting customer.

8. The method of claim 7 further comprising identifying a travel route of the requesting customer; and
identifying the availability of the service provider based on a proximity of the service provider to the travel route.

9. The method of claim 8 wherein generating guidance for the service provider comprises determining a desirability of the service provider to travel to a final destination of the travel route.

10. The method of claim 8 wherein identifying the availability of the service provider comprises:
identifying that the service provider is not available when the requesting customer begins traveling along the travel route;
identifying that the service provider will become available at a destination along the travel route; and
wherein notifying the service provider of the potential booking comprises notifying the service provider of the destination along the travel route as a meeting location with the requesting customer.

11. The method of claim 8 further comprising identifying a detour from the travel route along which the requesting customer may travel in order to meet with the service provider.

12. The method of claim 7 wherein generating guidance for the service provider comprises:
determining a desirability of the service provider to accept the potential booking; and
determining a desirability of the service provider to reject the potential booking.

13. The method of claim 12 wherein determining the desirability of the service provider to accept the potential booking comprises determining one of:
a wait minutes sub-score based on a number of minutes to be waited until the service provider can provide the service to the requesting customer;
a waiting location desirability sub-score based on a desirability of a location where the service provider will be waiting for the requesting customer;
a requested service sub-score based on a rank of the service of the potential booking by the service provider;
a subsequent client score based on a likelihood of getting a subsequent customer if the potential booking were to be accepted by the service provider; and
a next location score based on an ability of the service provider to be delivered to a desired location at an end of providing the requested service.

14. The method of claim 12 wherein determining the desirability of the service provider to reject the potential booking comprises determining one of:
a subsequent likelihood sub-score based on a likelihood of a customer other than the requesting customer to request another service booking at or near a current location of the service provider;
a better service sub-score based on a likelihood of a customer other than the requesting customer to request a higher-paid service; and
a present comfortability sub-score based on a comfortability of the service provider to remain at the current location of the service provider.

15. One or more computer readable storage media having program instructions stored thereon for allocating parking spaces in a parking lot, wherein the program instructions, when executed by a processing system, direct the processing system to at least:
identify a plurality of customers requesting a service able to be provided by at least one service provider of a pool of service providers;
identify an availability of the at least one service provider to provide the service to the requesting customer during a travel route from a starting location to an ending location;
for each available service provider:
notify the service provider of the plurality of customers requesting the service;
calculate a plurality of scores for each of the plurality of customers;
based on the plurality of scores, generate respective guidance information regarding effects of accepting a booking with each of the plurality of customers and effects of rejecting the booking with each of the plurality of customers; and
communicate the guidance information to the service provider via a service provider user interface system suggesting at least one optimal action regarding the plurality of customers;
receive an input decision from the service provider regarding booking with the plurality of customers; and
communicate the input decision to be presented via a customer user interface system to the requesting customer.

16. The one or more computer readable storage media of claim 15 wherein the program instructions that direct the processing system to display the guidance information further direct the processing system to display an optimal ranked list of the plurality of customers from which to accept a booking.

17. The one or more computer readable storage media of claim 15 wherein the program instructions that direct the processing system to display the guidance information further direct the processing system to display desirable drop-off locations for the available service provider after the service is calculated to be finished.

18. The one or more computer readable storage media of claim 15 wherein the program instructions that direct the processing system to display the guidance information further direct the processing system to display transportation mode score indicating a desirability of the type of transportation to be used during a travel route by each of the plurality of customers.

19. The one or more computer readable storage media of claim 18 wherein the program instructions further direct the processing system to calculate a higher transportation mode score for a high-privacy vehicle.

20. The one or more computer readable storage media of claim 19 wherein the high-privacy vehicle comprises a self-driving car.
